(19) United States
(12) Patent Application Publication
(10) Pub. No.: US 2007/0017351 A1
(43) Pub. Date: Jan. 25, 2007

(54) MUSICAL ABSOLUTE PITCH RECOGNITION INSTRUCTION SYSTEM AND METHOD

(75) Inventor: Christopher Aruffo, Highland Park, IL (US)

Correspondence Address: BELL, BOYD & LLOYD, LLC, PO BOX 1135, CHICAGO, IL, 60690-1135, US

(73) Assignee: ACOUSTIC LEARNING, INC., Gurnee, IL (US)

(21) Appl. No.: 11/457,976

(22) Filed: Jul. 17, 2006

Related U.S. Application Data
(60) Provisional application No. 60/701,247, filed on Jul. 20, 2005.

(51) Int. Cl. G10H 7/00

(52) U.S. Cl. 84/616

(57) ABSTRACT

The present system and method describes an ear training system and method designed to teach a subject the ability to recognize and perceive absolute pitch. The system and method present a melody word including a target pitch. The subject is then exposed to a query sound. The subject is then tasked to determine whether the target pitch is present in the query sound. A reinforcing sound and/or a visual indicia associated with the target pitch may be provided to assist the subject in determining the presence of the target pitch in the query sound.

### PRIORITY

This application is a non-provisional of, claims priority to and claims the benefit of U.S. Provisional Patent Application Ser. No. 60/701,247, filed Jul. 20, 2005, the entire contents of which are incorporated herein.

### BACKGROUND

The present disclosure relates to a system and method for instructing a person how to recognize absolute pitch.

Musicians increase their musical abilities by becoming able to identify musical tones as well as becoming able to create selected musical tones mentally and physically. Accurate recognition and reproduction of specific tones is critically important for singers or instrumentalists whose musicianship relies on subtle body mechanics.

Musicians often improve their musicality via separate tools and methods for ear training. Apart from and in addition to their production and reception of music, musicians drill to become more able to identify musical sounds by listening to musical sounds and attempting to identify them.

Absolute pitch training is a form of ear training. Scientists and educators have attempted to teach absolute pitch ability for over one hundred years with limited success. Conventional ear-training methods including absolute pitch training methods generally require subjects to memorize and identify tone sounds. For instance, a tone or series of tones is sounded, and the subject is required to identify the tones. The form of the identification is typically a linguistic label, either a letter name (e.g., “G”, “B-flat”, “F-sharp”) or a solfege syllable (e.g., “do”, “la”, “sol”). As an alternate method of identification, some methods have attempted to create synesthetic associations between tone sounds and visual colors, or motor associations between tone sounds and gestural movements. As an alternate method of presentation, some methods have required their subjects to listen repeatedly to specific musical tones to impress those tones upon a subject's memory.

Although some presentation-response modes are more efficient than others, they all follow the same basic methodical model by requiring their subjects to identify tones. The methods vary in the mode of presentation and manner of response required. The tones may be presented by the musician, a human partner, a computer or other suitable electronic machine. The subject's responses may be given vocally or kinesthetically (such as pressing a key or button). For adult absolute pitch training, however, traditional tone-identification models are generally ineffective.

Current tone identification methods claim to teach “absolute pitch” ability, which they sometimes define as the ability to name and recall musical tones. Although tone-identification training may assist subjects to become more skilled at identifying and recalling tone sounds, tone-identification training does not necessarily improve absolute pitch ability. This is apparent as absolute musical perception and production abilities of musicians trained with known tone identification methods do not resemble the absolute-pitch abilities of musicians who naturally possess absolute pitch. Moreover, tone identification training is not permanent and disappears without continued training, while absolute pitch ability is permanent and does not fade or vanish in the absence of continued training. Consequently, it is not surprising that no reports exist of an adult (who does not already possess absolute pitch) developing the ability to recognize absolute pitch as a result of deliberate tone-identification training.

The present disclosure defines absolute pitch ability as the ability to recognize and subsequently identify the unique psychological quality of a vibratory sound frequency, regardless of the context in which the vibratory sound frequency appears. Absolute pitch ability is a psychological process which renders a categorical absolute judgment along the spectrum of sound vibration. Conventional tone identification methods do not develop this psychological process. Known tone identification methods develop other skills instead. The following further explains significant reasons for this.

Conventional tone identification training is often based on indirect sensory cues. A subject such as a person may be trained to “feel” a musical tone, either by subjective assessment (such as “sounds mellow”) or by subjective similarity to another sensory type (such as visual color). The subject is thereby being trained either to respond to an extraneous sensation indirectly evoked by a musical input, or to generate a musical output indirectly provoked by an extraneous sensation. This manner of identification is not a direct judgment of the musical tone; rather, it is a judgment of a reaction caused by the aural stimulus, or of a sensory experience unrelated to the aural stimulus. Although such sensations may be consistent and repeatable, indirect identification trains a subject to identify an extraneous sensation, not a pitch sound.

Another shortfall of current tone identification is that it relies on verbal language names. Subjects are typically asked to identify tones by naming them, either with an alphabetic letter or a Latin syllable. However, self-reports and brain scans of people who have absolute-pitch (i.e., naturally) demonstrate that: (1) literal tone identification is a secondary event which occurs after an absolute sensory judgment has already been made; (2) language sounds activate different areas of the brain than do musical sounds; and (3) tone labeling and absolute judgment are separate neural processes. Training tone identification by linguistic labeling does not train a subject to make absolute judgments, nor does it develop the psychological process of making such judgments. Spoken language is a different mode of sound processing than musical comprehension, and training tone identification by linguistic association develops different areas of the brain than those involved in absolute perception.

Moreover, conventional tone identification methods that place significant effort into the memorization task have significant drawbacks. Tone memorization requires a subject to create a mental model of each individual tone sound, and each tone sound is an amalgam of aural characteristics including pitch; therefore, when the same pitch sound appears in a tone that possesses different characteristics (e.g., timbre, volume, etc) the tone may be completely unrecognizable, despite its having the same pitch as the memorized tone.

It is important to explain here that a tone is not the same as a pitch. Many known tone identification methods assume that identifying tones is equivalent to identifying pitches, and train a subject accordingly. This assumption is incorrect. A musical tone is in fact a simultaneous series of multiple pitch frequencies which are harmonically related and thus perceived as a unitary event. Furthermore, a single musical tone incorporates such additional characteristics as volume, spatial location, rhythmic position, scale degree, and timbre, among many others. Conventional tone identification methods make no explicit distinction between these characteristics, thus allowing a subject to mentally select and incorporate any or all of a tone's perceived characteristics into their memory construct of each tone. Therefore, when a subject hears a familiar pitch within an unfamiliar tone construct, the subject becomes unable to recognize and identify the sound. Such a subject has been trained to recognize and recall musical tones, and musical tones are not pitch frequencies.

Conventional tone identification methods fail to appreciate that the ability to acquire absolute pitch recognition diminishes as one gets older. A developmental change begins to occur in the psychology of normal children at approximately age five. After this occurs, normal children are increasingly unable to perceive individual characteristics of sounds, and increasingly unable to associate unfamiliar sensory characteristics with linguistic labels. This tendency is normally observed in language acquisition and development, but it is equally applicable to musical comprehension. No known tone identification method acknowledges this developmental change. Consequently, there is no absolute pitch training method which recognizes the need to accommodate an adult's learned perceptual strategies.

It has also been demonstrated that this developmental shift is a significant influence in absolute pitch training. A conventional music pedagogy trains young children to acquire absolute pitch. The success of this methodology, however, diminishes with students older than five years old and is very limited with students older than seven years old. This is due in part because different methods should be used for children who have not yet experienced this shift in their developing psychology.

The influence of this developmental shift on absolute pitch acquisition has been demonstrated directly. In one study, researchers attempted to train subjects to recognize a single absolute pitch via detection rather than tone identification. The researchers tested three age groups: ages 3-4, ages 5-6, and adult. Each of the age groups applied an entirely different mental strategy to accomplish the task, with significantly different results. Adults evidenced the specific strategy of treating the process as a memorization task, creating mental constructs of each tone and selecting categorically. This is what occurs in tone identification methods because it is the normal mental strategy for an adult to use.

Accordingly, a need exists for a system and method for developing or otherwise acquiring absolute pitch particularly for adults. Such a system and method should enable a subject to recognize a pitch characteristic within a sound event, regardless of the other characteristics which accompany that event. Thus, a further need exists for a pitch recognition instruction system and method that trains a subject to hear qualitative differences in a pitch characteristic once a subject is capable of recognizing a pitch characteristic thereby developing the psychological process of absolute pitch perception and judgment.

### SUMMARY

The present disclosure provides an instruction system and method for training a person to develop the ability to recognize absolute pitch. Generally, the system and method presents to the person a known Target Pitch within a variety of musical structures and contexts. Unlike traditional methods, the system and method does not require a subject to identify unknown pitch sounds. The system and method instead queries the subject to detect the presence or absence of the known Target Pitch. By presenting the same pitch characteristic in multiple different contexts, the present system and method trains a subject to discriminate pitch from other aural characteristics by perceptual differentiation. The subject thereby becomes able to distinguish pitch as a unique perceptual characteristic, separate from all other perceptual characteristics in a sound event. The system and method thereby directly develops the psychological skill of perceiving a pitch sound.

The present system and method uses the principle of perceptual differentiation to enable the psychological process of recognizing pitch sounds along a spectrum. Once a subject is trained to perceive the pitch characteristic, the present system and method introduces the subject to new pitch sounds in the same manner as the original Target Pitch. Learning new pitch sounds is also a process of perceptual differentiation in which the subject's mind, having learned to perceive pitch, recognizes and understands that the qualitative differences between the old and new experiences are the absolute values of the psychological pitch. Melody Words and colored Graphemes in certain embodiments are used to establish a precise and specific mental identity for each pitch sound. The system may therefore be used to present an individual with musical sounds of increasing complexity, and, by responding to these sounds, the individual subsequently gains absolute pitch ability via principles of perceptual differentiation.

In an embodiment, a pitch recognition instruction method is provided that includes presenting a melody word to a subject, the melody word including a target pitch, providing a query sound, the target pitch being present or absent in the query sound, and determining by the subject whether the target pitch is present in the query sound. A reinforcement sound that contains the target pitch may be provided to assist the subject in determining whether the target pitch is present in the query sound.

In an embodiment, the determination or assessment of the query sound by the subject produces a result whereby the method further includes assigning a perception level based on the result. The method in certain embodiments includes associating the target pitch with a visual indicia.

In an embodiment, the method includes selecting a pitch session selected from the group consisting of single pitch session and a multiple pitch session. In an embodiment, the target pitch may be weighted.

In a further embodiment, the query sound may be selected from the group consisting of a single tone, two tones, and a chord. In addition, the query sound and/or the melody word may include aural parameters selected from the group consisting of timbre, dynamic, duration, intonation, articulation, rhythm, and combinations thereof.

In an embodiment, a system and method for training absolute pitch is provided that includes generation of a melody word, the melody word containing a target pitch, generation of a query pitch, the target pitch present or absent in the query pitch, and indication of whether the query pitch includes the target pitch. In an embodiment, the indication generates a response and the system further includes assignment of a perception level based on the response. In an embodiment, the system also includes generation of a reinforcement sound, the reinforcement sound including the target pitch and may also include association of the target pitch with a visual indicia. The visual indicia may be selected from the group consisting of a noiseless grapheme, a printed symbol, a colored shape and combinations thereof.

In an embodiment, the melody word may include components selected from the group consisting of one or more tones, pitch session, timbre, perception level and combinations thereof. The target pitch may or may not be weighted.

In an embodiment, the system includes a pitch session which may be selected from the group consisting of single pitch and multiple pitch.

In an embodiment, the query sound and/or the melody word may be selected from the group consisting of a single tone, two tones, and a chord. In addition, the query sound and/or the melody word may include aural parameters selected from the group consisting of timbre, dynamic, duration, intonation, articulation, rhythm, and combinations thereof.

Additional features and advantages of the present disclosure are described in, and will be apparent from, the following Detailed Description and the Figures.

### BRIEF DESCRIPTION OF THE FIGURES

FIG. 1 is a schematic representation of a pitch recognition instruction system in accordance with the present disclosure.

FIGS. 2, 2A and 2B are exemplary complexity tables in accordance with the system and method of the present disclosure.

FIG. 3 is an example pitch table in accordance with the system and method of the present disclosure for teaching absolute pitch.

### DETAILED DESCRIPTION

The present system and method uses the following tools: (1) Target Pitch; (2) Melody Word(s); (3) Noiseless Graphemes; (4) Query Sound; and (5) Reinforcement Sound. These tools and their uses are described below.

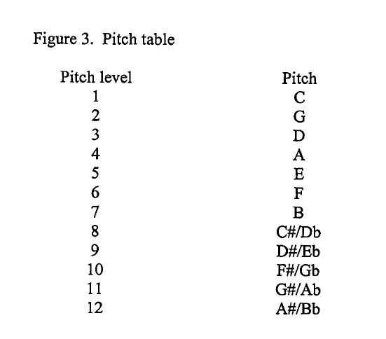

A Target Pitch is a specified absolute vibratory sound frequency. The system and method trains a subject by prompting that subject to detect the presence or absence of Target Pitches. Training begins with a single Target Pitch and no other Target Pitches are used until the subject graduates into a new Pitch Level via advanced performance. Although theoretically there is no advantage or disadvantage in selecting any particular pitch from any particular musical tradition to begin training, an embodiment of the system and method introduces pitches from the traditional equal-tempered Western chromatic scale in a specific order which as illustrated in FIG. 3. The order illustrated in FIG. 3 represents, from easiest to hardest, the difficulty with which musicians with absolute pitch were able to identify the twelve musical pitch classes in one study. Important to note is that a pitch or the target pitch is not the same as a tone or a sound. A tone and/or sound may include various aural parameters in addition to a pitch. Nonlimiting examples of aural parameters present in a tone/sound include timbre, dynamic, duration, intonation, articulation and rhythm as are commonly known in the art.

A Melody Word is a short melody whose first tone contains a designated pitch. A Melody Word includes as few as two tones to as many as five, ten or more tones. In an embodiment, the melody word includes from about four tones to about eight tones. A different Melody Word is designated for each tone of the Western chromatic musical scale. Through use of Melody Words, the system and method avoids training its subjects to memorize tones. Studies have demonstrated that people who do not possess absolute pitch are nonetheless able to accurately and consistently recall the absolute quality of a familiar melody. Although not wishing to be bound by any particular theory, use of Melody Words is somewhat comparable to the phenomenon of training language comprehension by using word examples, such as “‘K’ is for ‘Kite.’” An unknown abstract sound (a phoneme or a pitch) is presented as the initial sound of a simple idea (a word or melody) so that a subject may, by recalling the idea, mentally re-create the associated word and its designated pitch with confidence.

Noiseless Graphemes refer to printed symbols that do not already represent a sound, sound event, or noisemaker. In an embodiment, Noiseless Graphemes represent no existing sound so that they will not automatically activate areas of the brain which process sound. Noiseless graphemes or symbols can be used to objectively represent musical sounds on a page or on a screen. Nonlimiting examples of printed symbols which do represent sounds are the letter “R”, an exploding firecracker, or a car crashing. Nonlimiting examples of printed symbols which do not represent sounds are a green circle or an ice cream cone. For any musical sound, Noiseless Graphemes advantageously create a direct association with a concretely recognizable visual object, rather than a subjective association with an abstract sensory experience. Furthermore, the use of a visual object avoids the problem of cross-modal sound stimuli and additionally promotes paired-associate learning. Use of Noiseless Graphemes advantageously avoid traditional tone labeling and identification. Noiseless Graphemes serve as visual symbols for each pitch in the same way that printed letters serve as visual symbols for language phonemes. This method uses colored shapes as graphemes, where the pitch class is represented by the color of the shape.

Query Sounds are presented to a subject who is then required to evaluate the sound for the presence or absence of a Target Pitch. A Query Sound may or may not contain the Target Pitch. A Query Sound may be selected according to a Perception Level which a subject has reached in his or her training. It should be appreciated that a Query Sound need not be musical; however, a Query Sound should have a recognizable and identifiable pitch.

Following a subject's judgment of a Query Sound, an embodiment of the system and method presents a Reinforcement Sound which contains a Target Pitch. The system and method informs the subject of the presence of the Target Pitch prior to presenting the Reinforcement Sound. Reinforcement Sounds further refine a subject's comprehension of pitch and can help introduce a subject to more complex Query Sounds. Reinforcement sounds also boost confidence because a subject will be certain of hearing the specified Target Pitch.

Selection of a Pitch Level as shown in FIG. 3 introduces the subject to one of the twelve chromatic pitches. In an embodiment, the selected Pitch Level determines the target pitch.

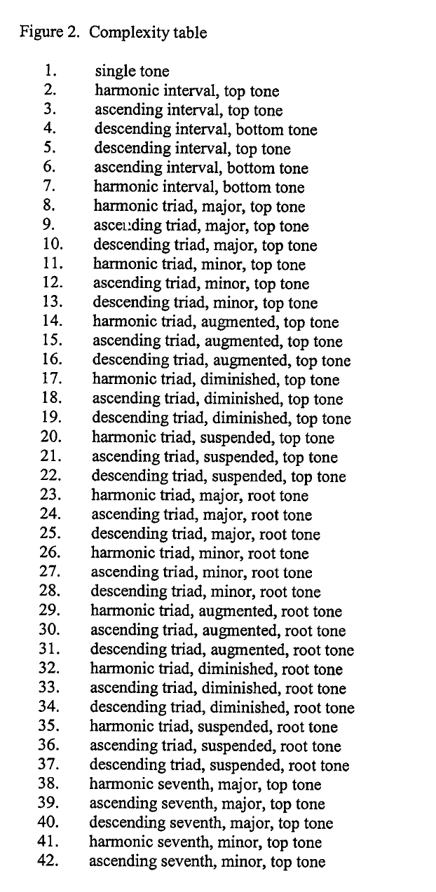

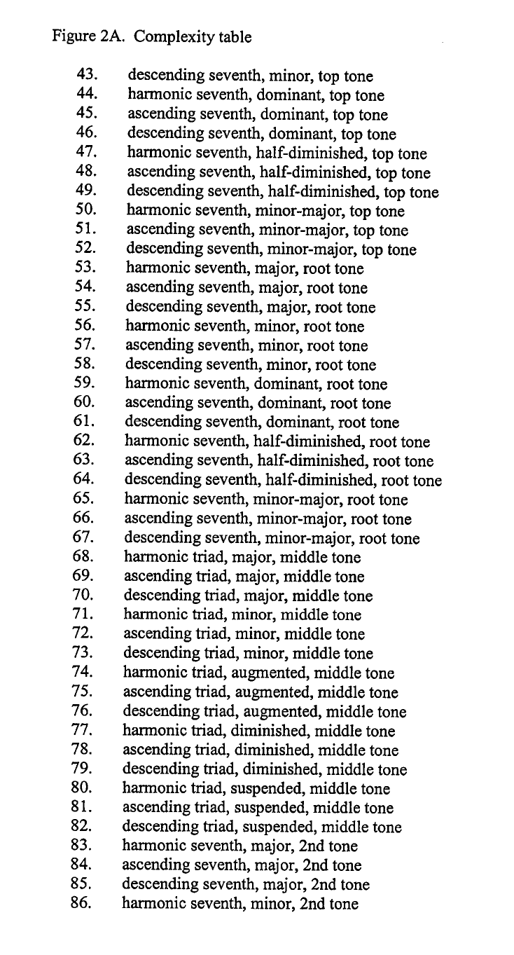

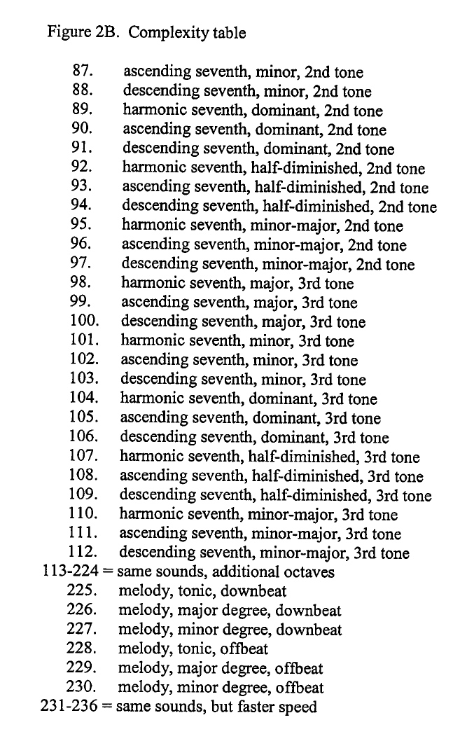

Perception Level is based on a subject's skill level. In an embodiment, the Perception Level may be one of 200 or more aural events as set forth in the complexity tables shown in FIGS. 2, 2A, and 2B. The Query Sound is based on the Perception Level of the subject. Accordingly, the Query Sound may range from a single tone (i.e. beginner) to extended chords in multiple octaves (i.e., advanced subject). Each aural event set forth in the complexity tables may or may not include additional aural parameters for tone as commonly known in the art. For example aural event #30 (Harmonic Seventh, Diminished, Root Tone) may be played on a piano, may be sung, may be performed by an orchestra or jazz/rock band, or may be played on one or more string, wind or percussion instruments. It is understood that the Query Sound may be performed live or may be recorded, or may be synthesized as is commonly known in the art.

An embodiment of the present pitch instruction method may proceed as follows. A training session may begin with a student or subject selecting a Pitch Level. The Pitch Level designates the Target Pitch. The method continues by presenting a Melody Word to the subject at the selected Pitch Level. One or more Query Sounds is/are then presented to the subject. The Query Sound may or may not include the target pitch. For each Query Sound, the subject is required to determine whether or not that Query Sound contains the Target Pitch. Following each judgment or determination by the subject, a Reinforcement Sound is presented. After a series of Query Sounds has been presented and evaluated by the subject, the correctness of the subject's determinations is assessed and a result is assigned. If the subject has achieved a high percentage of correct answers (i.e., a good result), the method advances the subject by one or two Perception Levels. If the subject has achieved a low result, the subject either remains at the same Perception Level or moves to a lower, less complicated Perception Level. When a subject moves to a new Perception Level, a new Pitch Level may or may not be selected.

In an embodiment, the method retains a subject's Pitch Level from the previous session, but begins the session with a Perception Level either of one (where one is the lowest level) or some level lower than the subject achieved in a previous session.

In an embodiment, the subject may select a pitch session. In a Single Pitch session, the Target Pitch is selected from the subject's current Pitch Level. In an Advanced Pitch Session, the Target Pitch may be selected from the subject's current Pitch Level or from a previously-achieved Pitch Level. In an embodiment, the Target Pitch may be weighted on the current Pitch Level. In an embodiment, the system may employ about 50% weighting on the current Pitch Level. However, this amount can vary in any suitable range. In an embodiment, the timbre of Query Sounds may be a default instrument sound, which may be either piano or the subject's preferred instrument, for example. The Advanced Pitch Sessions may continue until the subject's Perception Level for the newest Pitch Level exceeds the levels available on the Complexity Table. Thereafter, in an embodiment, the system and method continues with a new Pitch Level.

In a Custom Pitch Session, Target Pitches from all Pitch Levels equal to or less than the subject's current Pitch Level are presented with percentage weightings selected by the subject or an instructor. The timbre of Query Sounds may or may not be randomized and varied as desired. It is understood that the presentation of a Target Pitch and Melody Word, the provision of the Query Sound and provision of a Pitch Session may be provided by an instructor, liver/recorded local and/or instrumental musicians alone or in ensembles, or by way of recorded and/or synthesized tone generators (i.e., a computer, CD player, tape recorder, synthesizer or the like, or any other suitable device capable of providing such stimuli to a person).

In an embodiment, a subject begins at Pitch Level 1 with a Single Pitch Session. In an embodiment, Single Pitch Sessions may not be used after Pitch Level 1 and new pitches may be introduced with Advanced pitch sessions only. After a subject has achieved a maximum Perception Level for a newly-introduced pitch via Advanced Pitch Sessions, the subject may undertake Custom Pitch Sessions, featuring any or all pitches up to and including the subject's current Pitch Level, at the maximum Perception Level for each featured pitch.

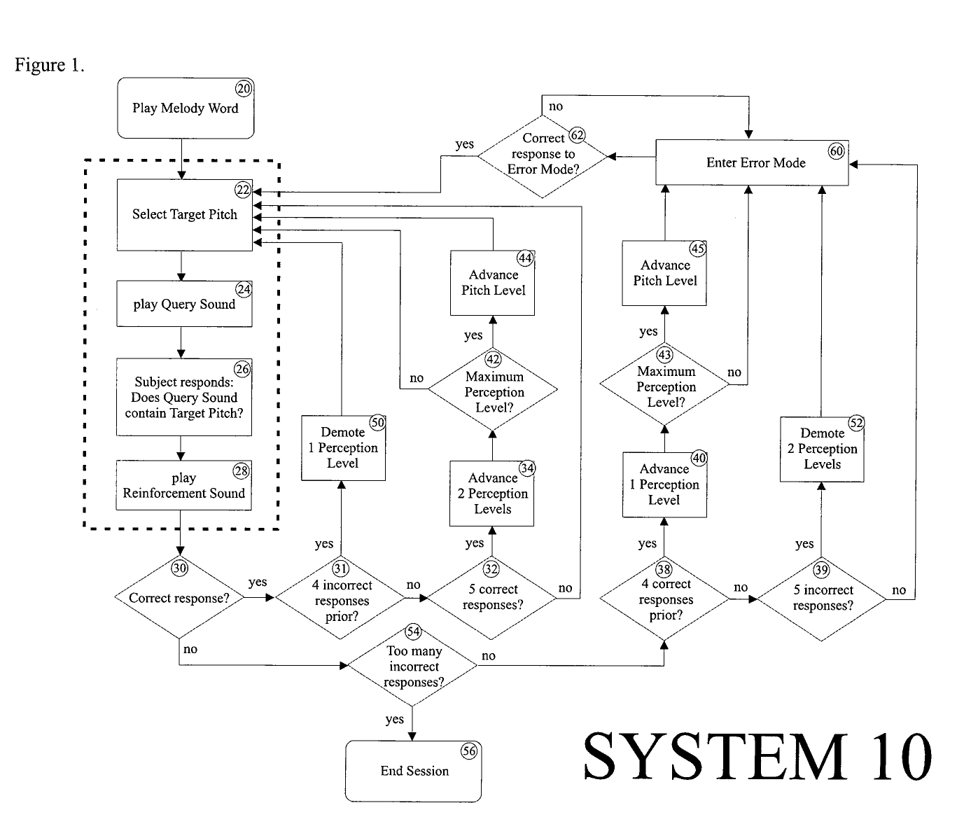

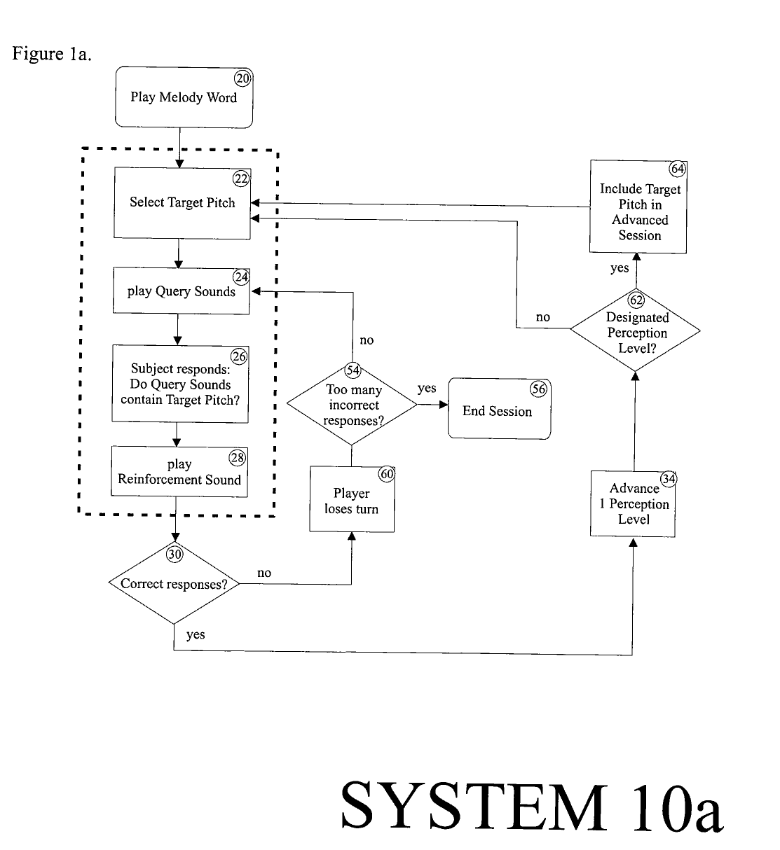

FIG. 1 illustrates a schematic representation of the pedagogical regimen provided by system 10. System 10 may include any device that produces audio/and or visual indicia as commonly known in the art. Nonlimiting examples of system 10 include a computer (with sound capability), a synthesizer, a keyboard (original or analog), an Internet connection to a website having audio and/or visual indicia and combinations thereof. In an embodiment, system 10 allows, accepts or otherwise recognizes the subject's initiated input through a keyboard (musical or otherwise) or similar data input apparatus. It should be appreciated that the method of the present disclosure could be implemented manually, through a mechanical system, through an electro-mechanical system, through an electronic system or through any other suitable system.

While the method can be provided by a human instructor and a selection of voice or musical instruments, either live or pre-recorded, one preferred embodiment of the system of the present disclosure which implements the methods described above is that of an electronic apparatus which includes a memory device, a processor, an interface or display device, and a sound producing device. In an embodiment, the instructions are loaded onto the memory device. The processor accesses the memory device and executes the instructions to interact with the subject via the display device or interface, and causes the production of sounds via the sound-producing device. The instructions may be delivered on physical media or by electronic transmission. In an embodiment, system 10 takes a subject through the following training steps: (1) Selecting and Playing the Melody Word; (2) Selecting the Target Pitch; (3) Playing the Query Sound; (4) enabling the subject to make or input a judgment; (5) Playing a Reinforcement Sound; (6) assessing Perception Level change; (7) assessing Pitch Level change; (8) responding to an error with an Error Session; (9) Repeating steps (2) to (8)

Melody Word, as indicated by block 20 in FIG. 1, is associated with the subject's current Pitch Level. In an embodiment Melody Word 20 is played once, at the beginning of a session, to begin the session; it is played again after thirty successful Target Pitch detections, and may be repeated by the subject during an Error Session. The generation of the Melody Word may be either live, pre-recorded or synthesized tone production as previously discussed.

System 10 then selects a Target Pitch 22 based on both the user's Pitch Level and on the type of session (i.e., Single pitch, Advanced pitch, Custom pitch). System 10 may also display a grapheme on a display device for the selected Target Pitch.

System 10 then plays a Query Sound as indicated by block 24. The generation of the Query Sound may be accomplished live, pre-recorded or synthesized as is commonly known in the art. Query Sound 24 may or may not contain Target Pitch 22. System 10 selects the structure of Query Sound 24 according to a Complexity Table. Nonlimiting examples of Complexity Tables utilized by system 10 are shown at FIGS. 2, 2A, and 2B. The Query Sound may be selected from any Perception Level up to and including the subject's achieved Perception Level for the current Target Pitch. In an embodiment, the Query Sounds may be weighted in the following manner:

| Available Perception Levels | Percentage weight |
|---|---|
| Top 25% | 75% |
| Next 25% | 15% |
| Next 25% | 7% |
| Lowest 25% | 3% |

The Target Pitches may be weighted as set forth above for an Advanced Pitch Session and/or a Custom Pitch Session.

System 10 may then prompt the subject to make or input a judgment in response to Query Sound 24 as shown in block 26 of FIG. 1. The subject determines the presence or absence of Target Pitch 22 in Query Sound 24. The indication of the presence/absence of the Target Pitch may be verbal, written or keyboard input. In an embodiment, if Target Pitch 22 is present within Query Sound 24, the subject indicates or inputs a positive response. If Target Pitch 22 is not present, the subject makes an alternate response.

System 10 provides a Reinforcement Sound as indicated by block 28. The generation of the Reinforcement Sound may be live, pre-recorded or synthesized as previously discussed. The structure of Reinforcement Sound 28 is selected from a Complexity Table such as one of the Complexity Tables illustrated in FIGS. 2, 2A and 2B. If the subject has made a correct answer, system 10 chooses Reinforcement Sound 28 from any Perception Level, unweighted but with respect to whether the subject's skill level currently includes multiple octaves and/or timbres. Otherwise, the system 10 chooses a Reinforcement Sound from a level equal to or lesser than the current Perception Level.

In an embodiment, if the subject has made a designated number of total incorrect responses (in an embodiment, this number is approximately eight responses) as indicated in decision diamond 54, system 10 terminates the session.

Following the subject's designated number of responses (such as the fifth response), system 10 evaluates the subject's number of correct answers as indicated in decision diamond 32 and computes a result for subject's performance. In an embodiment, if the subject has responded correctly to all designated sounds such as the five sounds, system 10 advances a designated number such as two Perception Levels for the current Target Pitch as indicated in block 34. If the subject has made a lower designated number of correct responses before making an incorrect response, such as four correct responses, as indicated in decision diamond 38, system 10 advances a lower designated number such as one Perception Level as indicted in block 40. If the subject has answered a lower number, such as 1-3 correct responses, as indicated in decision diamond 32, system 10 remains at the same Perception Level. If the subject has responded incorrectly to all designated sounds such as the five sounds, system 10 demotes a designated number such as two Perception Levels as indicated in block 52. If the subject has made a lower designated number of incorrect responses before making a correct response, such as 4 incorrect responses, as indicated in decision diamond 31, system 10 demotes a designated number such as one Perception Level as indicated in block 50.

When a subject's Perception Level exceeds the levels available as indicated in decision diamonds 42 and 43 on a Complexity Table such as the Complexity Table of FIG. 2, the system and method advances a new Pitch Level as indicated in block 44 and 45.

If a subject provides an incorrect answer, after evaluation system 10 initiates Error Mode as indicated in block 60. In Error Mode, system 10 generates a designated quantity such as six Query Sounds and presents them individually to the subject. The subject must indicate whether each of these Query Sounds contains the Target Pitch, either by selecting a colored grapheme representing the Target Pitch or selecting a colorless shape representing the absence of the Target Pitch. If the subject makes correct responses to all presented Query Sounds, as indicated in decision diamond 62, Error Mode is terminated and system 10 selects a new Target Pitch as indicated in block 22. If the subject fails to make correct responses to all presented Query Sounds, system 10 returns the subject to Error Mode, and the subject must correct his or her responses. Error Mode is terminated only when the subject has correctly responded to all presented Query Sounds.

In an embodiment, the instruction system may be in the form of an electronic game. The system may be provided by software and implemented on an electronic device such as a computer, a television or other suitable device equipped with an electronic game device as commonly known in the art. Each game may be a session of ear training. In one embodiment, when the subject begins a game, the system presents the player with a field of thirty targets, arranged in six columns and five rows. The targets function as soundless graphemes for the Target Pitches. The system selects the targets with appropriate weighting from among the Target Pitches which are to be used in the session. In one embodiment, a player's on-screen figure is a “base” which can shoot missiles at the target targets. At the start of a session, the system displays the player's base and plays the Melody Word whose first tone matches the current highest Pitch Level.

The system may generate a Query Sound and present the player with a “missile” which is loaded onto the base. The missile may be colored to represent the current Target Pitch. Upon hearing the Query Sound, the player indicates via the interface whether the Query Sound does or does not contain the Target Pitch. When a player chooses correctly, the missile may be launched at the targets; otherwise, the missile may be self-destructed, and an Error Session begins.

The system may generate a Reinforcement Sound either at the moment when the target is destroyed or when the missile self-destructs. When an target is destroyed, the Reinforcement Sound contains the Target Pitch represented by the destroyed target. When the missile self-destructs, the Reinforcement Sound contains the same Target Pitch as that tested by the Query Sound.

After playing the Reinforcement Sound, the system may advance the targets one column. The targets' space field may be ten columns across and ten rows high. When any one target reaches the side edge of the Space Field, all targets descend one row. If any target reaches the bottom of the screen, the base is destroyed and the system ends the session.

If a player makes an incorrect response to a Query Sound, the base is destroyed and the system initiates Error Mode. The player must listen to a designated number such as six Query Sounds and indicate the presence or absence of the Target Pitch in each Query Sound. A player may indicate the presence of the Target Pitch by assigning a colored target representing the Target Pitch to a Query Sound. A player may indicate the absence of the Target Pitch by assigning a colorless target to a Query Sound. When the player has assigned targets to each Query Sound, the system evaluates the player's responses. If all responses are correct, the system restores the base and terminates Error Mode. If all responses are not correct, the system may advance the targets by one column and prompt the player to revise his or her responses.

Following each of the player's responses, the system may randomly insert a special target. If the player destroys this special target, the system may cause the remaining targets to retreat by one row.

Perception Levels are represented by quasi-military medals and rankings. For every fifty Perception Levels achieved by a player, the system awards a new ranking, according to the following table:

| | |
|---|---|
| 1-50 | Cadet |
| 51-100 | Warrior |
| 101-150 | Captain |
| 151-200 | Major |
| 201-250 | Admiral |
| 251-304 | General |

The system may not display a numerical Perception Level. Instead, the system may display a proportional fragment of the medal currently being earned. For every 12 Perception Levels, the apparatus awards an additional commendation within the current rank, such as “First Class”, “Second Class”, or “Third Class”, and displays an icon representing that commendation.

When a player has destroyed all on-screen targets, the apparatus awards a “Wave Flag” displaying a Roman numeral. Wave Flags may be displayed on-screen to show a player how many total Wave Flags they have been awarded. Upon awarding a Wave Flag, the apparatus presents a new set of thirty targets and plays the Melody Word representing the highest available Pitch Level.

The system may end the session either at the player's initiative or by destroying the player's base. The system begins new sessions at a Perception Level equal to or less than the player's last fully achieved rank; for example, if a player reaches Perception Level 140 (Captain First Class) and ends the session, the next new session may begin no higher than Perception Level 100 (Captain Fourth Class). If a player reaches Perception Level 151 (Major Fourth Class) and ends their session, the next session may begin at Perception Level 151 (Major Fourth Class).

It should be appreciated that the present system and method may be implemented as other games or in other forms.

For example, in a further embodiment, a player's on-screen figure may be a frog. At the start of a Single Pitch session, the system displays the player's frog and plays the Melody Word whose first tone matches the current Pitch Level. The player may then be presented a designated quantity of lily pads such as five, where each lily pad is a noiseless grapheme representing a particular Target Pitch. The player may point to the lily pads to hear a Query Sound which may or may not contain the Target Pitch. The player may subsequently determine which of these Query Sounds does or does not contain the Target Pitch and submit their response to begin jumping the frog across each lily pad. An incorrect determination of Target Pitch would cause the frog to fall into the water at the location of the lily pad associated with an incorrect response, thus losing the player's turn.

To begin a new turn, the system may present a player with a new frog and repeat the Melody Word corresponding to the player's current Pitch Level.

When a player correctly identifies the designated quantity of Query Sounds as containing or not containing the Target Pitch, the system may play a Reinforcement Sound and the player may advance one Perception Level. When the number of Perception Levels achieved exceeds the number of levels available on the Complexity Table, the current Target Pitch may be added to the pitches included in or available to an Advanced Pitch session.

A designated quantity of Perception Levels such as one hundred-fifty may be designated for the initial Target Pitch, upon achieving which a player may not only begin subsequent Single Pitch sessions by freely selecting the Pitch Level of their Single Pitch session, but also may begin Advanced Pitch sessions featuring multiple Target Pitches. A player's progress in the Perception Levels of each individual Pitch Level may be tracked separately, so that each Single Pitch session may begin at the Perception Level indicated by the player's previous achievement, and Advanced Pitch sessions may not present a player with Perception Levels beyond their current level of achievement.

In an Advanced Pitch session, Target Pitches may be selected with equal weighting among all pitches made available to the Advanced Pitch session via the player's achievement in Single Pitch sessions. In a Custom Pitch session, a player may specify the Target Pitch selections and their designated weightings.

The system may end the session either at the player's initiative or when the designated number of lost turns such as five has been reached. The system begins new sessions at a designated number of Perception Levels such as ten lower than the player's last fully achieved level.

It should be understood that various changes and modifications to the presently preferred embodiments described herein will be apparent to those skilled in the art. Such changes and modifications can be made without departing from the spirit and scope of the present system and method and without diminishing its intended advantages. It is therefore intended that such changes and modifications be covered by the appended claims.

The invention is claimed as follows:

1. A pitch recognition instruction method, said method comprising:
presenting a melody word to a subject, the melody word including a target pitch;
providing a query sound, the target pitch present or absent in the query sound; and
enabling the subject to input a determination of whether the target pitch is present in the query sound.

2. The method of claim 1, further comprising providing a reinforcement sound, the reinforcement sound including the target pitch.

3. The method of claim 1, further comprising associating the target pitch with a visual indicia.

4. The method of claim 1, wherein the input of the determination produces a result, the method further comprising assigning a perception level based on the result.

5. The method of claim 1, further comprising weighting the target pitch.

6. The method of claim 1, wherein the melody word includes aural parameters selected from the group consisting of timbre, dynamic, intonation, rhythm and combinations thereof.

7. The method of claim 1, further comprising selecting a pitch session selected from the group consisting of single pitch session, an alternate pitch session and a multiple pitch session.

8. The method of claim 1, wherein the query sound is selected from the group consisting of a single tone, two tones, and a chord.

9. The method of claim 8, wherein the query sound includes aural parameters selected from the group consisting of timbre, dynamic, duration, intonation, articulation, rhythm, and combinations thereof.

10. A pitch recognition instruction method, said method comprising:
presenting a melody word to a subject, the melody word including a target pitch, wherein the melody word includes aural parameters selected from the group consisting of timbre, dynamic, intonation, rhythm and combinations thereof;
associating the target pitch with a visual indicia;
providing a query sound, the target pitch present or absent in the query sound;
providing a reinforcement sound, the reinforcement sound including the target pitch;
enabling the subject to input a determination of whether the target pitch is present in the query sound, wherein the input of the determination produces a result; and
assigning a perception level based on the result.

11. An absolute pitch training system for a person, said system comprising:
means for generating a melody word, the melody word containing a target pitch;
means for generating a query pitch, the target pitch present or absent in the query pitch; and
means for enabling a person to input an indication of whether the query pitch includes the target pitch.

12. The system of claim 11, wherein the melody word includes components selected from the group consisting of one or more tones, pitch session, timbre, perception level and combinations thereof.

13. The system of claim 11, further comprising means for generating a reinforcement sound, the reinforcement sound including the target pitch.

14. The system of claim 11, further comprising means for associating the target pitch with a visual indicia.

15. The system of claim 14, wherein the visual indicia is selected from the group consisting of a noiseless grapheme, a printed symbol, a colored shape and combinations thereof.

16. The system of claim 11, wherein the means for enabling a person to input an indication generates a response, and further comprising means for assigning a perception level based on the response.

17. The system of claim 11, further comprising means for weighting the target pitch.

18. The system of claim 11, wherein the melody word includes aural parameters selected from the group consisting of timbre, dynamic, intonation, rhythm and combinations thereof.

19. The system of claim 11, wherein the pitch session is selected from the group consisting of single pitch, Advanced pitch and Custom pitch.

20. The system of claim 11, wherein the query sound is selected from the group consisting of a single tone, two tones, a chord, and a melody.

21. The system of claim 20, wherein the query sound includes aural parameters selected from the group consisting of timbre, dynamic, duration, intonation, articulation, rhythm, and combinations thereof.

22. An absolute pitch training system for a person, said system comprising:
means for presenting a melody word to a subject, the melody word including a target pitch, wherein the melody word includes aural parameters selected from the group consisting of timbre, dynamic, intonation, rhythm and combinations thereof;
means for associating the target pitch with a visual indicia;
means for providing a query sound, the target pitch present or absent in the query sound;
means for providing a reinforcement sound, the reinforcement sound including the target pitch;
means for enabling the subject to input a determination of whether the target pitch is present in the query sound, wherein the input of the determination produces a result; and
means for assigning a perception level based on the result.

23. A memory device storing a plurality of instructions, that when executed by at least one processor, cause at least one sound producing device and at least one input device in communication with the at least one processor to:
present a melody word to a subject, the melody word including a target pitch;
provide a query sound, the target pitch present or absent in the query sound; and
enable the subject to input a determination of whether the target pitch is present in the query sound.

24. The memory device of claim 23, wherein the plurality of instructions, when executed by the at least one processor, cause the at least one sound producing device and the at least one input device in communication with the at least one processor to provide a reinforcement sound, the reinforcement sound including the target pitch.

25. The memory device of claim 23, wherein the plurality of instructions, when executed by the at least one processor, cause at least one display device in communication with the at least one processor, to provide a visual indicia associated with the target pitch.

26. The memory device of claim 23, wherein the plurality of instructions, when executed by the at least one processor, cause the input of the determination to produce a result and an assignment of a perception level based on the result.

27. The memory device of claim 23, wherein the plurality of instructions, when executed by the at least one processor cause a weighting of the target pitch.

28. The memory device of claim 23, wherein the melody word includes aural parameters selected from the group consisting of timbre, dynamic, intonation, rhythm and combinations thereof.

29. The memory device of claim 23, wherein the plurality of instructions, when executed by the at least one processor cause a selection of a pitch session selected from the group consisting of single pitch session, an alternate pitch session and a multiple pitch session.

30. The memory device of claim 23, wherein the query sound is selected from the group consisting of a single tone, two tones, and a chord.

31. The memory device of claim 30, wherein the query sound includes aural parameters selected from the group consisting of timbre, dynamic, duration, intonation, articulation, rhythm, and combinations thereof.

32. A memory device storing a plurality of instructions, that when executed by at least one processor, cause at least one sound producing device, at least one display device and at least one input device in communication with the at least one processor to:
present a melody word to a subject, the melody word including a target pitch, wherein the melody word includes aural parameters selected from the group consisting of timbre, dynamic, intonation, rhythm and combinations thereof.
associate the target pitch with a visual indicia;
provide a query sound, the target pitch present or absent in the query sound;
provide a reinforcement sound, the reinforcement sound including the target pitch;
enable the subject to input a determination of whether the target pitch is present in the query sound, wherein the input of the determination produces a result; and
assign a perception level based on the result.
